(19) United States
(12) Patent Application Publication
(10) Pub. No.: US 2010/0093513 A1
(43) Pub. Date: Apr. 15, 2010

(54) Refractory composition, formed refractory article, and sintered refractory article

(76) Inventors: Shigeru Nakama, Tokyo (JP); Norihiro Kihara, Tokyo (JP); Munehiko Fukase, Tokyo (JP)

Correspondence Address: SMITH PATENT OFFICE, 1901 PENNSYLVANIA AVENUE N W, SUITE 901, WASHINGTON, DC, 20006, US

(21) Appl. No.: 12/318,967

(22) Filed: Jan. 13, 2009

(30) Foreign Application Priority Data
Mar. 28, 2008 (JP) 2008-085573
Nov. 4, 2008 (JP) 2008-283001

(51) Int. Cl. C04B 35/565; C04B 35/583; C04B 35/584; C04B 35/00

(52) U.S. Cl. 501/89; 501/88; 501/92; 501/96.4; 501/97.1; 501/97.3

(57) ABSTRACT

A refractory composition having excellent erosion resistance and infiltration resistance to a molten metal and a formed article and a sintered article produced from the refractory composition are provided. The refractory composition comprises for 100 parts by mass of at least one compound selected from the group consisting of silicon nitride, boron nitride, and silicon carbide, 5 to 40 parts by mass of at least one compound selected from the group consisting of calcium fluoride, magnesium fluoride, calcium oxide or its precursor, magnesium oxide or its precursor, barium oxide or its precursor, and barium sulfate. The content of the silicon nitride, boron nitride, and silicon carbide in the composition is 20 mass % or more.

### BACKGROUND OF THE INVENTION

1. Field of the Invention

The present invention relates to a formed refractory article suitable for use in locations coming in direct contact with a molten metal in a casting apparatus for aluminum, magnesium, and the like, a sintered article, and a composition for producing a formed refractory article.

2. Description of Related Art

Refractory products for a molten metal are widely used as an inner clad material for forming parts coming in contact with a molten metal such as a drain pipe, a molten metal reservoir, a ladle, and the like of a casting apparatus for aluminum. The refractory material for a molten metal is called a sintered refractory material, a firebrick, or the like. The material is required to possess resistance to wetting by a molten nonferrous metal such as aluminum and good resistance to erosion and infiltration of a molten nonferrous metal.

JP-A-62-265151 discloses a forming material containing 0.1 to 7 wt % of glass fibers, 20 to 60 wt % of wallastonite fibers, and 40 to 80 wt % of alumina cements. This forming material is useful for manufacturing an inner wall clad material and a reservoir of a casting apparatus of a low melting-point metal.

JP-A-2000-119070 discloses a castable refractory material prepared by adding 4 to 10 wt % of alumina cement, 1 to 5 wt % of silica flour, 1 to 20 wt % of a fine powder of silicon nitride, and 1 to 15 wt % of carbon nitride to an alumina-silica raw material to make a total 100 wt % of a product. The castable refractory material with resistance to wetting by a molten nonferrous metal such as copper and aluminum and good resistance to erosion and infiltration of a molten nonferrous metal, particularly strong resistance to mechanical damages (wear) may be obtained.

However, the refractory product obtained from the forming material disclosed in JP-A-62-265151 produces a molten metal oxide film firmly adhering to the area of the surface contacted by a contact molten metal. Such a firmly adhering oxide film may produce an oxide film laminate on the area of contact by repeated contact of the refractory product and the molten metal. Such an oxide film laminate not only impairs the function of the refractory material, but also causes mechanical damages due to flow, coagulation, and contraction of the molten metal.

On the other hand, the castable refractory material of JP-A-2000-119070 does not produce an oxide film between the refractory product and the molten metal due to excellent erosion resistance (non-reactivity), but the refractory product is infiltrated by the molten metal by repeated contact and ultimately damaged.

An object of the present invention is therefore to provide a formed refractory article having excellent erosion resistance and infiltration resistance to a molten metal, a sintered refractory article, and a composition for producing a refractory product (refractory composition).

### SUMMARY OF THE INVENTION

In view of this situation, the inventors of the present invention have conducted extensive studies. As a result, the inventors have found that a formed refractory article and a sintered refractory article (hereinafter referred to from time to time collectively as “refractory product”) produced from a refractory composition comprising a material with high covalent bond properties such as silicon nitride, as a main component, and a material with high ionic bond properties at a specific proportion, if caused to come in contact with a molten metal, produces a molten metal oxide film which has properties of adhering to a refractory product only with difficulty and, due to these properties, does not form a laminate which is otherwise formed at locations of the refractory product repeatedly contacted by the molten metal, thereby exhibiting excellent erosion resistance and infiltration resistance to the molten metal. These findings have led to the completion of the present invention.

Specifically, the present invention provides a refractory composition comprising, for 100 parts by mass of at least one compound selected from the group consisting of silicon nitride, boron nitride, and silicon carbide, 5 to 40 parts by mass of at least one compound selected from the group consisting of calcium fluoride, magnesium fluoride, calcium oxide or its precursor, magnesium oxide or its precursor, barium oxide or its precursor, and barium sulfate, the content of the silicon nitride, boron nitride, and silicon carbide in the composition being 20 mass % or more.

The present invention further provides a formed refractory article comprising, for 100 parts by mass of at least one compound selected from the group consisting of silicon nitride, boron nitride, and silicon carbide, 5 to 40 parts by mass of at least one compound selected from the group consisting of calcium fluoride, magnesium fluoride, calcium oxide or its precursor, magnesium oxide or its precursor, barium oxide or its precursor, and barium sulfate, the content of the silicon nitride, boron nitride, and silicon carbide in the composition being 20 mass % or more.

The present invention further provides a sintered refractory article comprising, for 100 parts by mass of at least one compound selected from the group consisting of silicon nitride, boron nitride, and silicon carbide, 5 to 40 parts by mass of at least one compound selected from the group consisting of calcium fluoride, magnesium fluoride, calcium oxide or its precursor, magnesium oxide or its precursor, barium oxide or its precursor, and barium sulfate, the content of the silicon nitride, boron nitride, and silicon carbide in the composition being 20 mass % or more.

According to the present invention, a molten metal oxide film is formed by contact of the refractory product and the molten metal. Since the refractory product has properties of adhering to the oxide film only with difficulty, the oxide film does not form a laminate which is otherwise formed on the area of the refractory product repeatedly contacted by the molten metal. For this reason, the function of the refractory product is not impaired, and mechanical damages due to flow, coagulation, and contraction of the molten metal can be avoided. In addition, a maintenance operation of removing anchoring laminates is unnecessary, leading to a maintenance cost reduction. Furthermore, since the oxide film is formed between the refractory product and the molten metal, the refractory product has excellent erosion resistance and infiltration resistance to the molten metal.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a photograph of the surface of a test specimen showing a peeling or erosion phenomenon on the surface, FIG. 1B is a photograph of the surface of a test specimen showing anchoring of the solidified aluminum in the test specimen, and FIG. 1C is a photograph of the surface of a test specimen showing infiltration of molten aluminum in the test specimen.

FIG. 2A is a photograph of the surface of aluminum after 12 hours of a comparative test, FIG. 2B is a photograph similar to the photograph of FIG. 2A after 48 hours, FIG. 2C is a photograph of the surface of aluminum after 12 hours of an example test, FIG. 2D is a photograph similar to the photograph of FIG. 2C after 48 hours.

### DETAILED DESCRIPTION OF THE INVENTION AND PREFERRED EMBODIMENTS

The refractory composition of the present invention has a form of powder and includes a composition for an infinite form refractory product and a composition for a finite form refractory product. The composition for an infinite form refractory product is used as a raw material for a refractory product, that is, the composition is mixed with an appropriate amount of water, and the mixture is kneaded, fed into a formwork, hardened, and dried. The dried product is sintered as is or after further drying to form an inner clad (refractory product) having excellent fire resistance. The composition for a finite form refractory product is used also as a raw material for a refractory product with a finite form by extrusion forming or press forming, followed by a sintering step, for example. The refractory composition of the present invention is preferably used as the composition for an infinite form refractory product due to easy workability.

The refractory composition comprises for 100 parts by mass of at least one compound selected from the group consisting of silicon nitride, boron nitride, and silicon carbide (hereinafter referred to from time to time as “silicon nitride and the like”), 5 to 40 parts by mass of at least one compound selected from the group consisting of calcium fluoride, magnesium fluoride, calcium oxide or its precursor, magnesium oxide or its precursor, barium oxide or its precursor, and barium sulfate (hereinafter referred to from time to time as “calcium fluoride and the like”), wherein the content of the silicon nitride and the like is 20 mass % or more.

The silicon nitride and the like have strong covalent bond properties and capability of suppressing affinity (wetting properties) of the refractory product with the molten metal oxide film. The amount of silicon nitride and the like in the composition is 20 mass % or more, and preferably 22 mass % or more, and 2.5 times by mass or more of the amount of calcium fluoride and the like. If the amount of silicon nitride and the like in the composition is less than 20 mass % or less than 2.5 times by mass of the amount of calcium fluoride and the like, the molten metal oxide film anchors on the surface of the refractory product. If firmly adhering to the surface of the refractory product, the molten metal oxide film produces an oxide film laminate on the contact area by repeated contact of the refractory product and the molten metal. Such an oxide film laminate not only impairs the function of the refractory material, but also causes mechanical damages due to flow, coagulation, and contraction of the molten metal. In addition, the firmly attached (anchoring) laminate damages the refractory product when being removed during a maintenance operation.

The larger the amount of the silicon nitride and the like, the larger the effect of suppressing affinity of the refractory product with the molten metal oxide film. When the refractory product is produced by a sintering method without using a third component such as a binder, the upper limit of the silicon nitride and the like is 98 mass %. If a third component such as a binder is used, the upper limit is 95 mass %.

It is desirable to select silicon nitride and the like having a small particle size. Specifically, the particle size is 0.15 mm or less, preferably 0.10 mm or less, and particularly preferably 0.050 mm or less, but not less than 0.001 mm. Use of silicon nitride and the like having a small particle size increases the total surface area, which increases the effect of suppressing affinity of the refractory product with the molten metal oxide film. In addition, silicon nitride and the like having a small particle size can achieve a target effect with a smaller amount. Furthermore, silicon nitride and the like having a high purity are preferable. That is, the purity is preferably 90% or more, and more preferably 99% or more.

Silicon nitride, boron nitride, and silicon carbide may be used either individually or in combination of two or more. Among silicon nitride and the like, silicon nitride is preferable because the silicon nitride is comparatively inexpensive and exhibits the affinity-suppressing effect with only a small amount. Although silicon carbide is preferable because of its availability at a comparatively low price, the silicon carbide has an oxide layer on the surface in many cases and, therefore, a comparatively large amount must be added to the refractory composition. Boron nitride is preferable from the viewpoint of exhibiting the affinity-suppressing effect with a comparatively small amount, but is comparatively expensive. Beside silicon nitride, diamond and silicon are materials having strong covalent properties. These materials, however, cannot be used in practice due to extremely high cost, instability at a high temperature, or the like.

Calcium fluoride and the like are materials with strong ionic bond properties. These materials are used for the purpose of forming a molten metal oxide film in the interface of the refractory product and the molten metal. Calcium fluoride and the like have ionic bond properties equivalent to or stronger than the oxides, for example, an aluminum oxide, of the contacting molten metal. The stronger the ionic bond properties, the larger the effect of forming the oxide film. Thus, it is possible to obtain a satisfactory effect with a small content in the refractory composition.

The amount of calcium fluoride and the like to be added is 5 to 40 parts by mass, and preferably 5 to 35 parts by mass for 100 parts by mass of silicon nitride. A molten metal oxide film can be formed in the interface of the refractory product and the molten metal by dispersing the calcium fluoride and the like in the silicon nitride and the like in the above-mentioned proportion.

If the amount of the calcium fluoride and the like in the refractory composition of the present invention is too small, the molten metal oxide film cannot be formed in the interface of the refractory product and the molten metal. Too large an amount of calcium fluoride and the like is undesirable. If the amount of calcium fluoride and the like is too large, the effect of forming a molten metal oxide film is predominant, causing the resulting molten metal oxide film to anchor on the surface of the refractory product.

In addition, because the material with strong ionic bond properties such as calcium fluoride generally has a large volume expansion rate with heating, the refractory composition with a large content of calcium fluoride and the like results in a refractory product having low thermal shock resistance. Accordingly, the upper limit of calcium fluoride and the like in the refractory composition of the present invention is preferably 15 mass %, and particularly preferably 12 mass %.

It is desirable to select calcium fluoride and the like having a small particle size. Specifically, the particle size is 0.15 mm or less, preferably 0.10 mm or less, and particularly preferably 0.050 mm or less, but not less than 0.001 mm. Use of calcium fluoride and the like having a small particle size results in a large total surface area, which makes it possible to form an oxide film possessing appropriate releasability on the surface of the refractory product if added in the above-mentioned amount. In addition, calcium fluoride and the like with a high purity is preferable. That is, the purity is preferably 90% or more, and more preferably 99% or more.

Calcium fluoride, magnesium fluoride, calcium oxide or its precursor, magnesium oxide or its precursor, barium oxide or its precursor, and barium sulfate may be used either individually or in combination of two or more. Among the calcium fluoride and the like, calcium fluoride is most preferable due the strong ionic bond properties.

As an example of the precursor of calcium oxide, calcium carbonate can be given. As an example of the precursor of magnesium oxide, magnesium carbonate can be given. As an example of the precursor of barium oxide, barium carbonate can be given. These precursors are easily decomposed by heating. Therefore, these are present respectively as calcium oxide, magnesium oxide, or barium oxide in the formed refractory article after drying or in the sintered refractory article after heating.

When the refractory composition of the present invention is a composition for an infinite form refractory product, it is preferable to add alumina cement as a hardening material. There are no particular limitations to the alumina cement used in the present invention. A commercially available product may be used. Alumina cement containing 70 wt % or more of Al₂O₃ is preferable from the viewpoint of infiltration resistance and erosion resistance. The amount of alumina cement is preferably 4 to 50 wt % in the refractory composition and 5 to 100 parts by mass for 100 parts by mass of the silicon nitride and the like. If the amount is too small, the hardening speed is slow and the strength is insufficient. Since alumina cement has comparatively strong ionic bond properties, the alumina cement may impair the above-mentioned effect of controlling wettability of silicon nitride and the like if added in too large an amount. Therefore, the amount of alumina cement is appropriately determined taking the amount of silicon nitride and the like into consideration. If the amount of alumina cement is too large, fire resistance and thermal shock resistance are impaired. In addition, the composition requires a large amount of water during the processing step and, therefore, requires a long time for drying.

The refractory composition of the present invention may contain a powdery filler and an aggregate as optional components. The addition of these optional components may reduce the amount of silicon nitride and the like which are comparatively expensive materials and can increase mechanical strength of the refractory product. As examples of the filler and aggregate, alumina, amorphous silica, mullite, bauxite, chamotte, pyrophyllite, quartzite, zircon, ceramic balloon, and the like can be given.

The particle diameter of the filler and aggregate is preferably three times or more of the particle diameter of silicon nitride and the like and calcium fluoride and the like in order to maintain the effect of the filler and aggregate without impairing the effect of the silicon nitride and the like and calcium fluoride and the like. Specifically, the particle diameter of the filler and aggregate is 0.1 to 10 mm, for example. Although the amount of the filler and aggregate may be appropriately determined according to the use of the refractory product and the content of other components, such an amount is preferably not more than 60 wt %. When silica flour and the like are added for producing a compact product, the amount of silica flour is preferably not more than 10 wt %. The particle diameter of the silica flour is 0.01 to 30 μm. The addition of such silica flour makes the product become compact and increases the strength of the resulting formed article.

When the refractory composition of the present invention is a composition for a refractory product with an infinite form, an appropriate amount of a dispersant such as sodium hexametaphosphate, a hardening promoter such as lithium carbonate and calcium hydroxide, a hardening retardant such as boric acid and sodium silicon fluoride, and an organic fiber such as polypropylene fiber for preventing an explosion may be added to the composition.

The formed refractory article of the present invention can be obtained by a commonly-known method such as a method comprising mixing the refractory composition in the form of a powder with an appropriate amount of water, kneading the mixture, hardening the kneaded mixture in a formwork, and drying, or a method of forming the refractory composition in the form of a powder by extrusion forming or press forming, followed by drying. Since the component composition of the formed refractory article of the present invention is the same as that of the refractory composition of the present invention, the description of such a component composition is omitted. The formed refractory article of the present invention has excellent thermal shock resistance, strength, erosion resistance, and infiltration resistance almost equivalent to the later-described sintered refractory article. Therefore, the formed refractory article may be used as is.

When the formed refractory article is an infinite formed refractory article, that is, a castable refractory product, the amount of water in the mixture of the refractory composition and water is 5 to 40 wt %. The mixture is preferably fed to a formwork while deaerating using a flexible vibrator or the like. Wood, a metal, a synthetic resin, and the like may be used as the material of the formwork. A synthetic resin is preferable due to the dimensional accuracy, dimensional stability, and the like. After having been fed into the formwork, the refractory product is dried at room temperature for about one day, removed from the formwork, and dried at about 110° C. for 24 hours. The refractory product may not be removed from the formwork if left therein below freezing point. Therefore, it is preferable to allow the mixture of the refractory composition and water to age around the room temperature after feeding into the formwork.

The sintered refractory article of the present invention can be obtained by sintering the formed refractory article of the present invention. The sintering is carried out at 600 to 1300° C. for 0.5 to 4 hours, whereby the water of crystallization in the formed refractory article can be removed. Since the component composition of the sintered refractory article of the present invention is the same as that of the refractory composition of the present invention, the description of such a component composition is omitted. The sintered refractory article of the present invention has excellent thermal shock resistance, strength, erosion resistance, and infiltration resistance almost equivalent to the formed refractory article.

The sintered refractory article of the present invention can be produced by a reactive sintering method, for example, without using a hardening material such as alumina cement. One example of the reactive sintering method comprises preparing a refractory composition containing 20 mass % or more of silicon nitride by adding from 5 to 40 parts by mass of calcium oxide or the like, as a material with strong ionic bond properties, to a mixture of 50 parts by mass of silicon nitride and 35 parts by mass of metal silicon, adding an organic material as a binder and water to the refractory composition, sufficiently mixing the mixture by stirring, filling the mixture in a formwork, press-forming, and drying to obtain a formed product, which is then treated with heat for 20 hours at a high temperature of 1400° C., for example, in a nitrogen gas atmosphere. A sintered refractory article can be obtained in this manner without using a hardening material such as alumina cement. The metal silicon reacts with nitrogen gas to produce silicon nitride (Si₃N₄).

The formed refractory article and sintered refractory article contain calcium fluoride and the like which have strong ionic bond properties uniformly dispersed in the matrix of silicon nitride and the like which have strong covalent bond properties. Therefore, when brought into contact with a molten metal, these refractory products can form a molten metal oxide film in the interface with the molten metal by the action of calcium fluoride and the like in the dispersion layer. This oxide film has a function of a barrier suppressing erosion and infiltration of the refractory product by a molten metal. On the other hand, since the refractory product has properties of adhering to the oxide film only with difficulty, the oxide film can be removed without forming a laminate even if the refractory product is repeatedly contacted by the molten metal. For this reason, the function of the refractory product is not impaired, and mechanical damages due to flow, coagulation, and contraction of the molten metal can be avoided.

### EXAMPLES

The present invention will be described in more detail by examples, which should not be construed as limiting the present invention.

### Example 1

### Preparation of Refractory Composition

A refractory composition was prepared from the components shown in Table 1. The average particle diameters of silicon nitride, boron nitride, silicon carbide, calcium fluoride, magnesium fluoride, calcium oxide, magnesium oxide, barium oxide, and barium sulfate were respectively 0.03 mm, 0.1 mm, 0.03 mm, 0.05 mm, 0.05 mm, 0.05 mm, 0.05 mm, 0.05 mm, and 0.05 mm. The alumina cement contained 75 mass % of Al₂O₃ and had a particle diameter of 0.03 mm. In preparing a refractory composition for an infinite form refractory product, the raw materials were sufficiently mixed using a ball mill to homogeneously disperse each component in the composition.

### Preparation of Formed Refractory Article

100 parts by mass of the refractory composition and 18 parts by mass of water were mixed and kneaded. The resulting kneaded product was poured into a plate formwork and the formwork was vibrated to sufficiently deaerate. The resulting refractory product was dried at an ordinary temperature for one day, removed from the formwork, and dried at 110° C. for 24 hours to obtain a formed refractory article.

### Preparation and Evaluation of Sintered Refractory Article

The formed refractory article was sintered at 700° C. for three hours to obtain a plate of a sintered refractory article (test specimen). The following tests of molten metal resistance were carried out using the resulting test specimen to evaluate erosion of the test specimen due to the chemical reaction between the test specimen and aluminum (indicated as “erosion by chemical reaction” in Tables), anchoring of aluminum to the surface of the test specimen (indicated as “aluminum anchoring” in Tables), and infiltration of aluminum into the test specimen (indicated as “aluminum infiltration” in Tables). The results are shown in Table 1.

### Test of Molten Metal Resistance

The plate-like test specimen was horizontally placed in an electric furnace, and molten aluminum at 700° C. was dropped thereon point-blank. Then, the test specimen was maintained as is for 12 hours. The test specimen was removed from the furnace after reaching the room temperature to observe reactivity of the test specimen and aluminum. In this test, because almost no oxide film layer was formed on the surface of the molten aluminum immediately before being brought into contact with the test specimen, it was possible to substantially cause the molten aluminum to contact directly with the test specimen.

<Erosion of Test Specimen by Chemical Reaction with Aluminum>

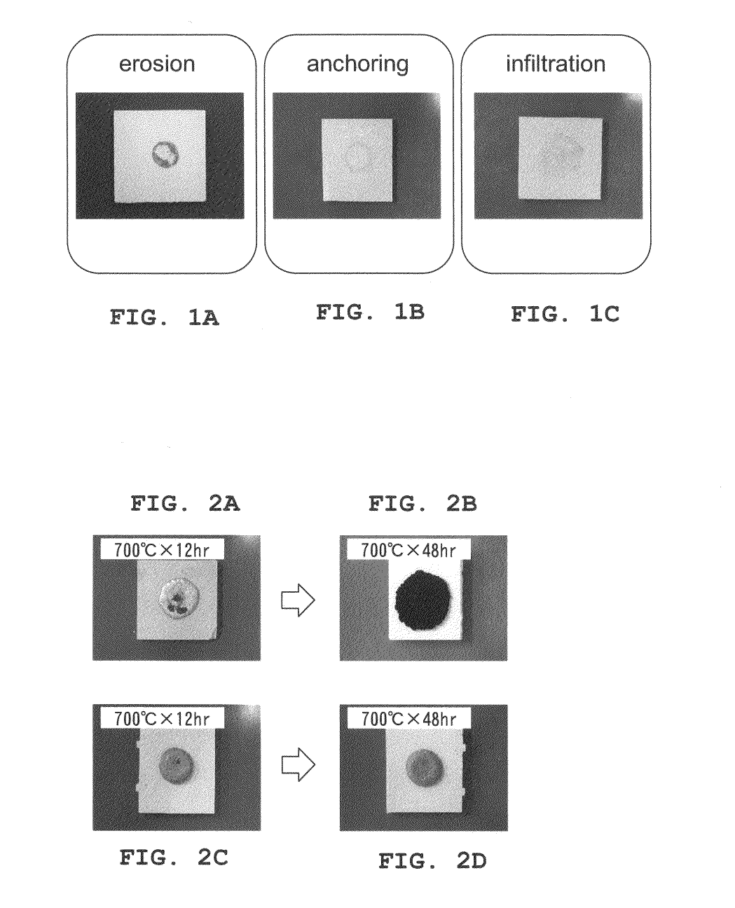

When the test specimen has high chemical reactivity with the molten aluminum, the surface of the test specimen turns into a reduced substance due to deprivation of oxygen by the molten aluminum. This is reflected by a phenomenon of peeling or erosion of the surface after removal of the solidified aluminum, and can be confirmed by naked eye observation of the surface of the test specimen. The test specimen with no peeling or erosion of the surface was evaluated as “Good” and the test specimen of which the surface was peeled off or eroded was rated as “Bad”. FIG. 1A is a photograph of the surface of a test specimen on which a peeling or erosion phenomenon is seen.

### <Anchoring of Aluminum on the Surface of Test Specimen>

When the test specimen is formed from a material having strong ionic bond properties, an oxide film is formed on the surface of the molten aluminum by contact with the test specimen. Since both the oxide film and the material having strong ionic bond properties are strongly polarizing, the oxide film tends to anchor on the surface of the test specimen easily. The anchoring conditions can be confirmed by anchoring resistance when removing the solidified aluminum from the test specimen. The anchoring conditions can also be judged from the state of the surface after removing the anchoring material against the anchoring resistance. The test specimen without anchoring solidified aluminum was evaluated as “Good” and the test specimen with anchoring solidified aluminum was rated as “Bad”. FIG. 1B is a photograph of the surface of a test specimen in which anchoring of the solidified aluminum is observed. It can be seen that a part of the surface of the test specimen was peeled off.

<Infiltration of Aluminum into Test Specimen>

When the test specimen is formed from a material having strong covalent bond properties, an oxide film is not formed on the contact surface of the molten aluminum and the test specimen, but the test specimen is simply infiltrated by the molten aluminum. Infiltration of aluminum into the test specimen can be observed by the naked eye. When the degree of infiltration of molten aluminum into the test specimen is significant, the test specimen is damaged when removing the solidified aluminum. Infiltration of aluminum can be judged also from the conditions of damage. Infiltration of aluminum into the test specimen cannot usually be judged when erosion of the test specimen due to the chemical reaction with aluminum is observed. A test specimen in which infiltration of aluminum was not seen was evaluated as “Good” and a test specimen having aluminum infiltration observed was rated as “Bad”. FIG. 1C is a photograph of the surface of a test specimen in which aluminum infiltration is seen.

<Formation of Aluminum Oxide Film on the Contact Surface of the Test Specimen with Aluminum>

When the test specimen is prepared from a material having strong covalent bond properties without using a material having strong ionic bond properties, an oxide film is not formed on the surface of the aluminum. The aluminum surface has metallic gloss after the test as shown in FIG. 2A. When the test specimen was maintained for a further 24 hours (total of 48 hours) at 700° C., oxide film formation on the surface after the test was remarkable as shown in FIG. 2B. On the other hand, in the case of the test specimen of Example 1, it can be seen that a moderate oxide film was formed judging from the degree of coloration on the aluminum surface after the test, as shown in FIG. 2C. When the test specimen was maintained for further 24 hours (total of 48 hours) at 700° C., there was almost no change in the oxide film as shown in FIG. 2D. The reason is that the oxide film initially formed on the surface of aluminum functions as a barrier which suppresses further formation of the oxide film. The test specimen in which formation of a moderate oxide film on the contact surface with aluminum was seen was evaluated as “Good”, otherwise the test specimen was evaluated as “Bad”. It has been confirmed that if a moderate oxide film is formed on the contact surface of the test specimen with aluminum, no oxide film laminate is produced by repeated contact of a refractory product with molten aluminum in actual equipment. The oxide film formability of the test specimen of Example 1 was good and indicated as “Good”.

### Examples 2 to 10

Powdery refractory compositions, refractory formed articles, and sintered refractory articles were prepared and evaluated in the same manner as in Example 1, except for using the components shown in Tables 1 and 2 in the amounts shown. The amount of water was varied and appropriately adjusted according to the type of materials in a range of about 16 to 20 parts by mass. The results are shown in Tables 1 and 2. The other materials were aggregates and fillers with a particle diameter of 0.2 to 4 mm. The oxide film formability of the test specimen of Examples 2 to 10 was good and indicated as “Good”.

### Comparative Examples 1 to 9

Powdery refractory compositions, refractory formed articles, and sintered refractory articles were prepared and evaluated in the same manner as in Example 1, except for using the components shown in Table 3 in the amounts shown. The amount of water was varied and appropriately adjusted according to the type of materials in a range of about 16 to 20 parts by mass. The results are shown in Table 3. The particle diameter of wallastonite was 0.04 mm. The oxide film formability of the test specimen of Comparative Examples 1 to 9 was bad and indicated as “Bad”.

TABLE 1

| | | | Example | | | | | | | |
|---|---|---|---|---|---|---|---|---|---|---|
| | | | 1 | 2 | 3 | 4 | 5 | 6 | 7 | 8 |
| Composition | Material A with covalent | Silicon nitride | 78 | 30 | | | 15 | 30 | 30 | 30 |
| (wt %) | bond properties | Silicon carbide | | | 45 | | 15 | | | |
| | | Boron nitride | | | | 25 | | | | |
| | Material B with ionic | Calcium fluoride | 10 | 5 | 5 | 5 | 5 | | | |
| | bond properties | Magnesium fluoride | | | | | | 5 | | |
| | | Calcium oxide | | | | | | | 10 | |
| | | Magnesium oxide | | | | | | | | 10 |
| | Cement | Alumina cement | 12 | 15 | 15 | 20 | 15 | 15 | 13 | 13 |
| | Other materials | Amorphous silica | | 50 | 35 | 50 | 50 | | 47 | |
| | | Chamotte | | | | | | 50 | | 47 |
| | | Wallastonite | | | | | | | | |

| | | | | | | | | | |
|---|---|---|---|---|---|---|---|---|---|
| | Amount of material B for 100 parts by mass of | 12.8 | 16.7 | 11.1 | 20 | 16.7 | 16.7 | 33.3 | 33.3 |
| | material A (part by mass) | | | | | | | | |
| Test result | Erosion by chemical reaction | Good | Good | Good | Good | Good | Good | Good | Good |
| | Aluminum anchoring | Good | Good | Good | Good | Good | Good | Good | Good |
| | Aluminum infiltration | Good | Good | Good | Good | Good | Good | Good | Good |

TABLE 2

| | | | Example | |
|---|---|---|---|---|
| | | | 9 | 10 |
| Composition | Material A with covalent | Silicon nitride | 30 | 30 |
| (wt %) | bond properties | | | |
| | Material B with ionic | Barium sulfate | 10 | |
| | bond properties | Barium oxide | | 10 |
| | Cement | Alumina cement | 13 | 13 |
| | Other materials | Amorphous silica | 47 | |
| | | Chamotte | | 47 |

| | | | |
|---|---|---|---|
| | Amount of material B for 100 parts by mass | 33.3 | 33.3 |
| | of material A (part by mass) | | |
| Test result | Erosion by chemical reaction | Good | Good |
| | Aluminum anchoring | Good | Good |
| | Aluminum infiltration | Good | Good |

TABLE 3

| | | | Comparative Example | | | | | | | | |
|---|---|---|---|---|---|---|---|---|---|---|---|
| | | | 1 | 2 | 3 | 4 | 5 | 6 | 7 | 8 | 9 |
| Composition | Material A with | Silicon nitride | | | | 85 | | | | 15 | 30 |
| (wt %) | covalent bond | Silicon carbide | | | | | | | | | |
| | properties | Boron nitride | | | | | | | | | |
| | Material B with | Calcium fluoride | | | | | 5 | 5 | 5 | 5 | 25 |
| | ionic bond | Magnesium fluoride | | | | | | | | | |
| | properties | Calcium oxide | | | | | | | | | |
| | | Magnesium oxide | | | | | | | | | |
| | Cement | Alumina cement | 40 | 20 | 35 | 15 | 40 | 20 | 35 | 15 | 15 |
| | Other materials | Amorphous silica | | | 35 | | | | 30 | 65 | 40 |
| | | Chamotte | | 80 | | | | 75 | | | |
| | | Wallastonite | 60 | | 30 | | 55 | | 30 | | |

| | | | | | | | | | | |
|---|---|---|---|---|---|---|---|---|---|---|
| | Amount of material B for 100 parts by | — | — | — | — | — | — | — | 33.3 | 33.3 |
| | mass of material A (part by mass) | | | | | | | | | |
| Test result | Erosion by chemical reaction | Good | Good | Bad | Good | Good | Good | Bad | Bad | Bad |
| | Aluminum anchoring | Bad | Bad | Bad | Good | Bad | Bad | Bad | Bad | Bad |
| | Aluminum infiltration | Good | Good | — | Bad | Good | Good | — | — | — |

As can be seen from Tables 1 and 2, all refractory products of Examples 1 to 10 formed a moderate oxide film and no aluminum anchoring was seen. For this reason, no oxide film laminate was produced by repeated contact of the refractory products with molten aluminum in actual equipment. In addition, the refractory products of Examples 1 to 10 exhibited excellent erosion resistance and infiltration resistance. Due to strong ionic bond properties of the refractory products, the test specimens of Comparative Examples 1 and 2 and 5 to 7 had an aluminum oxide film anchored on the surface. Erosion due to the chemical reaction with molten aluminum was observed in the test specimens of Comparative Example 3. Since the materials used in Comparative Example 4 has strong covalent bond properties, there was no oxide film formed on the surface of the test specimen. In addition, the test specimen was not eroded by a chemical reaction. However, infiltration of molten aluminum was observed in the test specimen of Comparative Example 4. In Comparative Example 8, anchoring of aluminum oxide film on the surface of the test specimen and erosion due to the chemical reaction of the molten aluminum and the aggregate were observed, since the material contained only a small amount of silicon nitride in spite of the combined use of the silicon nitride with calcium fluoride. In Comparative Example 9, anchoring of aluminum oxide film on the surface of the test specimen and erosion due to the chemical reaction of the molten aluminum and the aggregate were observed, since the material contained too large an amount of calcium fluoride in spite of the combined use of silicon nitride with calcium fluoride.

Obviously, numerous modifications and variations of the present invention are possible in light of the above teachings. It is therefore to be understood that, within the scope of the appended claims, the invention may be practiced otherwise than as specifically described herein.

What is claimed is:

1. A refractory composition comprising, for 100 parts by mass of at least one compound selected from the group consisting of silicon nitride, boron nitride, and silicon carbide, 5 to 40 parts by mass of at least one compound selected from the group consisting of calcium fluoride, magnesium fluoride, calcium oxide or its precursor, magnesium oxide or its precursor, barium oxide or its precursor, and barium sulfate, the content of the silicon nitride, boron nitride, and silicon carbide in the composition being 20 mass % or more.

2. The refractory composition according to claim 1, further comprising 5 to 100 parts by mass of alumina cement for 100 parts by mass of at least one compound selected from the group consisting of silicon nitride, boron nitride, and silicon carbide.

3. A formed refractory article comprising, for 100 parts by mass of at least one compound selected from the group consisting of silicon nitride, boron nitride, and silicon carbide, 5 to 40 parts by mass of at least one compound selected from the group consisting of calcium fluoride, magnesium fluoride, calcium oxide or its precursor, magnesium oxide or its precursor, barium oxide or its precursor, and barium sulfate, the content of the silicon nitride, boron nitride, and silicon carbide in the composition being 20 mass % or more.

4. The formed refractory article according to claim 3, further comprising 5 to 100 parts by mass of alumina cement for 100 parts by mass of at least one compound selected from the group consisting of silicon nitride, boron nitride, and silicon carbide.

5. A sintered refractory article comprising, for 100 parts by mass of at least one compound selected from the group consisting of silicon nitride, boron nitride, and silicon carbide, 5 to 40 parts by mass of at least one compound selected from the group consisting of calcium fluoride, magnesium fluoride, calcium oxide or its precursor, magnesium oxide or its precursor, barium oxide or its precursor, and barium sulfate, the content of the silicon nitride, boron nitride, and silicon carbide in the composition being 20 mass % or more.

6. The sintered refractory article according to claim 5, further comprising 5 to 100 parts by mass of alumina cement for 100 parts by mass of at least one compound selected from the group consisting of silicon nitride, boron nitride, and silicon carbide.
